(19) United States
(12) Patent Application Publication
(10) Pub. No.: US 2021/0076660 A1
(43) Pub. Date: Mar. 18, 2021

(54) VAPORIZER DEVICE FOR USE WITH INSECT REPELLENT CARTRIDGE

(71) Applicant: PIC Corporation, Linden, NJ (US)

(72) Inventor: ERIC RUBEL, Westfield, NJ (US)

(21) Appl. No.: 17/020,106

(22) Filed: Sep. 14, 2020

Related U.S. Application Data
(60) Provisional application No. 62/899,406, filed on Sep. 12, 2019.

(51) Int. Cl. A01M 13/00; A01M 29/12

(52) U.S. Cl. CPC A01M 13/00; A01M 2200/01; A01M 29/12

(57) ABSTRACT

An electric vaporizer device includes a base with a power source and a heating element and an insect repellent containing cartridge removably mounted in the base.

### CROSS-REFERENCE TO RELATED APPLICATIONS

The present application claims benefit of and priority to U.S. Provisional Patent Application Ser. No. 62/899,406, filed Sep. 12, 2019 and entitled ELECTRIC VAPORIZER DEVICE FOR USE WITH INSECT REPELLANT CARTRIDGE, the entire content of which is incorporated by reference herein.

### BACKGROUND

### Field of the Disclosure

The present invention generally relates to pest management. More specifically, the present invention relates to an electric vaporizer device that includes a replaceable insect repellent containing cartridge to vaporize the insect repellent and create a zone of vaporized repellent around the device that is substantially insect free.

### Related Art

During mild weather, many people enjoy spending additional time outside, during both daytime and nighttime hours. One drawback of spending time outdoors, especially during warm weather, is that insect activity often increases at these times. This can make enjoying the outdoors difficult. Various insect repellent devices for outdoor use have been introduced, for example, repellent candles, however, these products release combustion bi-products including carcinogens that may cause health problems.

Accordingly, it would be useful to provide a portable vaporizing device that includes an active and effective insect repelling substance that avoids the problems noted above.

### SUMMARY

An object of the present disclosure is to provide an electric vaporizer device that includes a removable cartridge including an insect repellent material, that, when vaporized, surrounds the vaporizer and creates a vapor cloud of repellent that is substantially insect free.

An electric vaporizer device in accordance with an embodiment of the present disclosure includes a base, wherein the base includes: a power source; a heating element; an input element connected to the heating element and power source; a protrusion extending from a bottom of the cartridge and sized and shaped to be received in the base; and a reservoir area configured to hold a supply of insect repellent material, wherein the heating element is thermally coupled to the reservoir area when the cartridge is mounted on the base such that heat from the heating element vaporizes at least a portion of the insect repellent material and the vaporized insect repellent material exits the electric vaporizer device to provide a cloud of vaporized insect repellent material around the electric vaporizer device.

In embodiments, the base includes a control circuit operatively connected to the heating element and the input element and configured to activate the heating element.

In embodiments, the control circuit includes a programmable logic device configured to activate the heating element in accordance with a heating pattern.

In embodiments, the control circuit includes a timer wherein the control circuit is configured to activate the heating element for a predetermined period of time based on the timer.

In embodiments, the device includes a heating circuit connected to the heating element and the input element and configured to activate the heating element based on input provided via the input element.

In embodiments, the heating circuit includes a timer and activates the heating element for a predetermined period of time following the input from the input element.

In embodiments, the cartridge further comprises a top surface including one or more openings configured to allow vaporized insect repellent to exit.

An electric vaporizer device in accordance with another embodiment of the present disclosure includes: a base, wherein the base includes: a power source; a heating element; an input element connected to the heating element and the power source; a cartridge removably mounted in the base, wherein the cartridge includes: a protrusion extending from a bottom of the cartridge and sized and shaped to be received in the base; a reservoir area configured to hold a supply of insect repellent material; and a wick extending from a first end positioned in the reservoir area and in contact with the insect repellent material to a second end that extends out of the protrusion and adjacent to the heating element when the cartridge is mounted on the base such that heat from the heating element vaporizes insect repellent material that flows from the first end of the wick to the second end of the wick and the vaporized insect repellent material exits the electric vaporizer device to provide a cloud of vaporized insect repellent material around the electric vaporizer device.

In embodiments, the base includes a control circuit operatively connected to the heating element and the input element and configured to activate the heating element.

In embodiments, the control circuit includes comprises a programmable logic device configure to activate the heating element in accordance with a heating pattern.

In embodiments, the control circuit includes a timer wherein the control circuit is configured to activate the heating element for a predetermined period of time based on the timer.

In embodiments, the device includes a heating circuit connected to the heating element and the input element and configured to activate the heating element based on input provided via the input element.

In embodiments, the heating circuit includes a timer and activates the heating element for a predetermined period of time following the input from the input element.

In embodiments, the base includes a front surface including one or more openings formed therein to allow vaporized insect repellent to exit.

An electric vaporizer device in accordance with another embodiment of the present disclosure includes: a base, wherein the base includes: a power source; a first electrical contact operatively connected to the power source; an input element connected to the first electrical contact and operable to control power supplied to the first electrical contact; a cartridge removably mounted in the base, wherein the cartridge includes: a protrusion extending from a bottom of the cartridge and sized and shaped to be received in the base; a reservoir area configured to hold a supply of insect repellent material; a second electrical contact configured for connection to the first electrical contact; and a heating element connected to the second electrical contact such that the heating element is activated and deactivate based on power supplied via the second electrical contact from the first electrical contact; wherein the heating element vaporizes at least a portion of the insect repellent material and the vaporized insect repellent material exits the electric vaporizer device to provide a cloud of vaporized insect repellent material around the electric vaporizer device.

In embodiments, the base includes a control circuit operatively connected to the input element and the first electrical contact and configured to control power provided to the first electrical contact.

In embodiments, the control circuit comprises a programmable logic device configured to control the supply of power in accordance with a heating pattern.

In embodiments, the control circuit includes a timer wherein the control circuit is configured to provide power to the first electrical contract for a predetermined period of time based on the timer.

In embodiments, the device includes a heating circuit connected to the heating element and the input element and configured to activate the heating element based in input provided via the input element.

In embodiments, the heating circuit includes a timer and activates the heating element for a predetermined period of time following the input from the input element.

In embodiments, the cartridge further comprises a top surface including one or more openings configured to allow vaporized insect repellent to exit.

This and other objects shall be addressed by embodiments of the present invention as set forth herein.

### BRIEF DESCRIPTION OF THE DRAWINGS

Exemplary embodiments of the present invention will be described with references to the accompanying figures, wherein:

FIG. 1 illustrates a perspective view of an electric vaporizer device in accordance with an embodiment of the present disclosure;

FIG. 2 illustrates a front view of the electric vaporizer device of FIG. 1 in accordance with an embodiment of the present disclosure;

FIG. 3 illustrates a side view of the electric vaporizer device of FIG. 1 in accordance with an embodiment of the present disclosure;

FIG. 4 illustrates removal of the insect repellent cartridge from the base of the electric vaporizer device of FIG. 1 and the bottom surface of the insect repellent cartridge in accordance with an embodiment of the present disclosure;

FIG. 4A illustrates a cross-sectional view of the base of the electric vaporizer device of FIG. 1 in accordance with an embodiment of the present disclosure;

FIG. 4B illustrates a rear view of the electric vaporizer device of FIG. 1 in accordance with an embodiment of the present disclosure;

FIG. 5 illustrates a more detailed view of the bottom surface of the insect repellent cartridge and the top surface of the base of the electric vaporizer device of FIG. 1 in accordance with an embodiment of the present disclosure;

FIG. 5A is an exemplary block diagram illustrating connections between a heating element, power supply and switch or other input device in the electric vaporizer device of FIG. 1 in accordance with an embodiment of the present disclosure;

FIG. 5B is an exemplary block diagram illustrating connections between a control circuit, heating element, power supply and switch or other input device in the electric vaporizer device of FIG. 1 in accordance with another embodiment of the present disclosure;

FIG. 6 illustrates a perspective view of an electric vaporizer device in accordance with another embodiment of the present disclosure;

FIG. 7 illustrates a front view of the electric vaporizer device of FIG. 6 in accordance with an embodiment of the present disclosure;

FIG. 8 illustrates a side view of the electric vaporizer device of FIG. 6 in accordance with an embodiment of the present disclosure;

FIG. 9 illustrates removal of the insect repellent cartridge from the base of the electric vaporizer device of FIG. 6 and the bottom surface of the repellent cartridge in accordance with an embodiment of the present disclosure;

FIG. 9A illustrates a cross-sectional view of the base of the electric vaporizer device of FIG. 6 in accordance with an embodiment of the present disclosure;

FIG. 9B illustrates a rear view of the electric vaporizer device in accordance with an embodiment of the present disclosure;

FIG. 10 illustrates a more detailed top view of the base of the vaporizer device of FIG. 6 in accordance with an embodiment of the present disclosure;

FIG. 11 illustrates a perspective view of an electric vaporizer device in accordance with another embodiment of the present disclosure;

FIG. 12 illustrates a front view of the electric vaporizer device of FIG. 11 in accordance with an embodiment of the present disclosure;

FIG. 13 illustrates a side view of the electric vaporizer device of FIG. 11 in accordance with an embodiment of the present disclosure;

FIG. 14 illustrates removal of the repellent cartridge from the base of the electric vaporizer device of FIG. 11 and the bottom surface of the insect repellent cartridge in accordance with an embodiment of the present disclosure;

FIG. 14A illustrates a cross-sectional view of the base of the electric vaporizer device of FIG. 11 in accordance with an embodiment of the present disclosure;

FIG. 15 illustrates a more detailed view of the bottom surface of the insect repellent cartridge and the top view of the base of the vaporizer device of FIG. 11 in accordance with an embodiment of the present disclosure; and

FIG. 16 illustrates an exemplary view of an electric vaporizer device attached to a user's body in accordance with an embodiment of the present disclosure.

### DETAILED DESCRIPTION

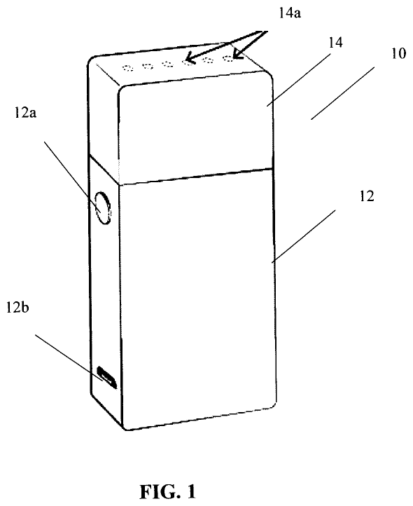

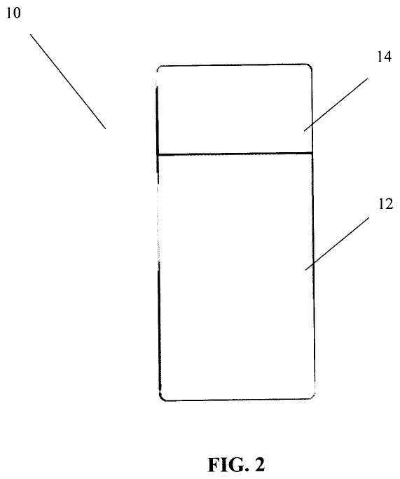

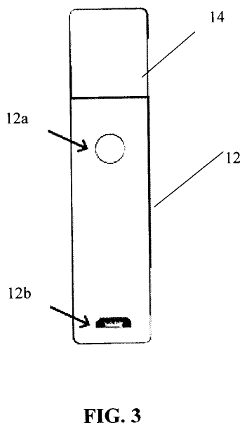

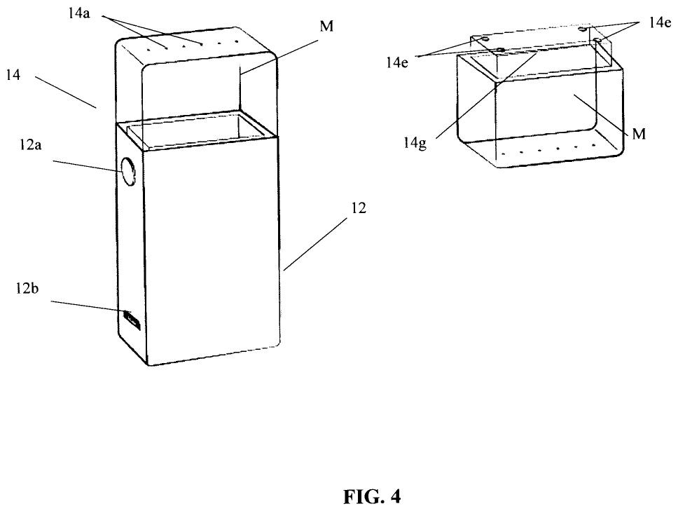

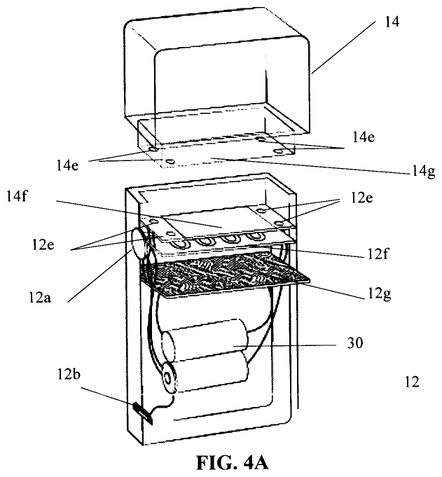

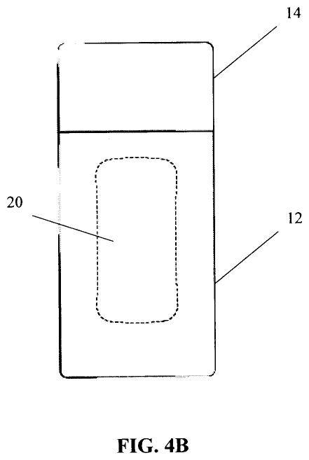

The present invention generally relates to an electric vaporizer device 10 (see FIG. 1, for example) that vaporizes an insect repellent material M (see FIG. 4, for example) to provide a cloud or concentration of vaporized insect repellent that spreads around the device 10 to provide a substantially insect free area around the vaporizer device. In embodiments, such as illustrated in FIGS. 1-5, for example, the electric vaporizer device 10 may include a base 12 and a removable insect repellent cartridge 14 mounted thereon. In embodiments, the top of the cartridge 14 may include a plurality of openings 14a through which vaporized insect repellent material passes out of the cartridge 14 and into the air around the vaporizer device 10 to repel insects in the area surrounding the device 10. In embodiments, the cartridge 14 may include an internal chamber or reservoir containing the insect repellent material M. In embodiments, the insect repellent material M may be in the form of a liquid, a polymer and/or a gel, to name a few. In embodiments, the insect repellent material M may include metofluthrin, however, other insect repellent material M may be used. In embodiments, the insect repellent material M may be in the form of an immersive foam solvent, as indicated in FIG. 4, for example.

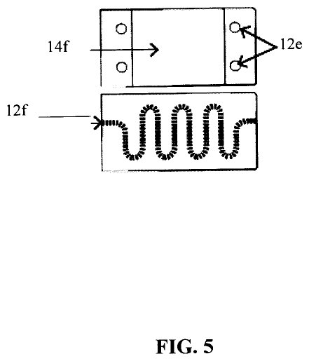

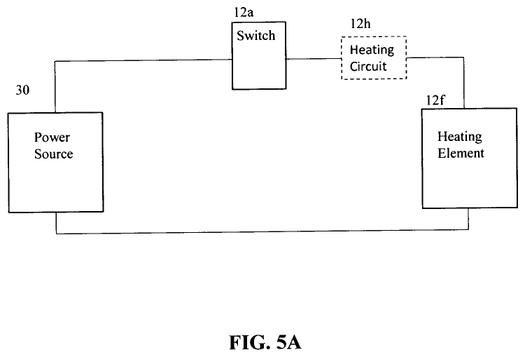

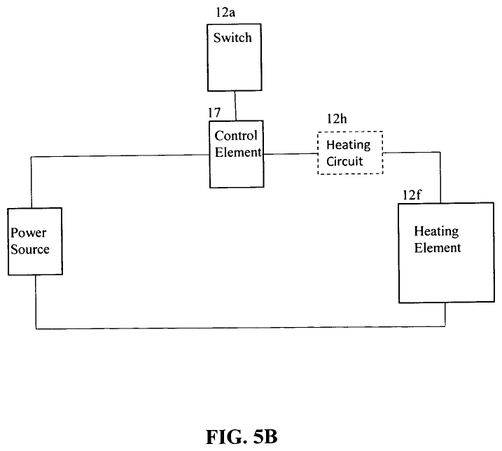

In embodiments, the base 12 may include one or more power sources 30 (see FIG. 4A and 5A, for example). In embodiments, the power source(s) 30 may be one or more batteries. In embodiments, the power source(s) 30 may be one or more rechargeable batteries. In embodiments, the power source(s) 30 may be any suitable power supply element(s). In embodiments, the base 12 may include a charging receptacle 12b which may be connected to an external AC or DC power supply to recharge the power source 30 in the base 12. In embodiments, an external AC or DC power supply may be used to provide power directly and the power source 30 may be or may include a transformer. In embodiments, the base 12 may include a heating element 12f that is powered by the power source 30. In embodiments, the heating element 12f may be provided as, or on a top surface of, the base 12 such that it is in contact with a bottom surface of the insect repellent cartridge 14 when the cartridge is mounted on the base 12, as shown in FIGS. 1-3, for example. In embodiments,

In embodiments, the heating element 12f may be selectively activated via a switch 12a, or other input element, provided on the base 12. In embodiments, the switch 12a may directly activate the heating element 12f. FIG. 5A illustrates an exemplary block diagram illustrating an exemplary connection between the power source, switch 12a and heating element 12f. In embodiments, a timer may be used to activate the heating element 12f for a predetermined period of time. In embodiments, the switch 12a may be used to activate the timer. In embodiments a control circuit 17 (see FIG. 5B, for example) may be provided and may include, implement or be operatively connected to the timer. In embodiments, the control circuit 17 may be operatively connected to the switch 12a, the power source 30, the heating element 12f and/or the heating circuit 12h. In embodiments, the control circuit 17 may control activation of the heating element 12f based on input provided by the switch 12a, the timer and/or other instructions that may be provided to the control circuit and implemented by the control circuit. In embodiments the control circuit 17 may be a discrete circuit. In embodiments, the control circuit 17 may be a microprocessor or other programmable logic device. While FIG. 5B illustrates the inclusion of the control circuit 17, it is noted that a control circuit is not required. In embodiments, the heating element 12f may remain active after the switch 12a is actuated until the switch 12a is actuated a second time to deactivate the heating element 12f. In embodiments, actuating the switch 12a a second time may reset a timer used to control the heating element 12f to keep the heating element 14a active for a longer period of time. While the term “switch” is used, element 12a may be any input element including but not limited to a button, switch or touchpad, to name a few. In embodiments, the heating element 12f may be connected to a heating circuit 12h that may control activation of the heating element 12f in a desired pattern based on input from the switch 12a or the control circuit 17 for example. While the heating circuit 12h is illustrated in the block diagrams of FIGS. 5A and 5B, it is noted that the heating circuit 12h is not necessary and the heating element 12f may be driven directly by the switch 12a or control circuit 17. In embodiments, the heating circuit 12h may be provided on printed circuit board 12g provided on the base 12. In embodiments, the heating element 12f may be turned on and off over a period of time to provide for a desired pattern of heating. In embodiments, the switch 12a, may be connected to the heating circuit 12h to begin or terminate such a desired heating pattern. In embodiments, a timer may activate the heating element 12f for a predetermined period of time after the switch 12a is engaged, for example 5 minutes, 10 minutes, 15 minutes, etc. such that that the heating element 12f turns off automatically after the predetermined period of time. In embodiments, activation of the switch 12a may interrupt operation of the heating element 12f or a timer used to activate the heating element, or may reset operation of the timer. In embodiments, activation of the switch 12a, may begin the pattern of activating the heating element 12f and deactivating it to provide a desired level of heating. In embodiments, one or more fans may be electrically connected to the switch 12a and/or the control circuit 17 and selectively activated to blow vaporized insect repellent material M out of the vaporizer device 10. In embodiments the one or more fans may operate only when the heating element 12f is activated. In embodiment, the fan(s) may operate when the heating element 12f is activated and for a period of time before and/or after the heating element 12f is deactivated. In embodiments, the fan(s) may operate in a pattern that may be based on the heating pattern provided by the heating circuit 12h or the control circuit 17. In embodiments, the switch 12a may be or may be connected to the control circuit 17, which may be a programmable device, such as a microprocessor or other programmable logic device, that may be used to control the heating element 12f in accordance with a set of commands or rules to provide the heating pattern or otherwise. In embodiments, the heating circuit 12h may be or include the control circuit 17. In embodiments the heating circuit 12h may include one or more discrete circuit elements or may be implemented on a printed circuit board such as the PCB 12g. In embodiments the control circuit 17 may also be implemented on or mounted on the PCB 12g. In embodiments, the heating element 12f may include the one or more timers discussed above that may be used to control activation and deactivation of the heating element 12f.

In embodiments, the cartridge 14 may include a protrusion 14g that extends downward into a top portion of the base 12 (see FIG. 4A, for example). A metal plate 14f may be provided in contact with the heating element 12f and the protrusion 14g of the cartridge. In embodiments, the metal plate 14f may be heated by the heating element 12f of the base 12 when the cartridge 14 is mounted on the base and transfers heat to the protrusion 14g. In embodiments, the metal plate 14f may be attached to the protrusion 14g. In embodiments, the metal plate 14f may be attached to the base 12. In embodiments, the insect repellent material M may be provided in the cartridge 14 and may be heated via the metal plate 14f and protrusion 14g. In embodiments, heating of the metal plate 14f heats the protrusion 14g and the insect repellent such that the insect repellent vaporizes and escapes out the openings 14a in the top of the cartridge 14. In embodiments, the fan(s) may be mounted in the cartridge 14 to blow the vaporized insect repellent out of the openings 14a. In embodiments, the protrusion 14g may directly contact the heating element 12f to provide heat to vaporize the insect repellent material. In embodiments, the protrusion 14g may be positioned adjacent to the heating element 12f.

In embodiments, the cartridge 14 may be removably attached to the base 12. In embodiments, the protrusion 14g at the bottom of the cartridge 14 may include one or more first fastening elements 14e to removably mount the cartridge to the base 12. In embodiments, the top surface of the metal plate 14f may include one or more second fastening elements 12e to cooperate with the first fastening elements to removably mount the cartridge 14 on the base. In this embodiment, the metal plate 14f is part of and secured within the base 12. In embodiments, the first fastening elements 14e and second fastening elements 12e may be complimentary magnetic elements that attract each other to connect the cartridge 14 to the base 12. In embodiments the first fastening elements 14e and second fastening elements 12e may include any suitable fastening structure that allows for removable mounting of the cartridge 14 on the base 10. In embodiments, the fastening elements 14e and 12e may be connected using a snap fit connection. In embodiments, the fastening elements 14e and 12e may be connected using twist lock connection, however, any suitable connecting structure may be used.

In operation, as noted above, a user may activate the switch 12a to begin operation of the device 10. In embodiments, actuation of the switch 12a may activate the heating element 12f, which, in turn, heats the metal plate 14f and/or the protrusion 14g as well as the insect repellent material M in the cartridge 14 to vaporize it. In embodiments, the plate 14f need not be metal provided that it is made of a material that is a good conductor of heat. That is, in embodiments, the plate 14f may be made of any thermally conductive material. In embodiments, the protrusion 14g may also be made of a thermally conductive material. In embodiments, the protrusion 14g may directly contact or be positioned adjacent to the heating element 12f such that the plate 14f may be not be used. The vaporized insect repellent material M may escape via the openings 14a. In embodiments, the activation of the switch 12a may also activate the one or more fans to aid in dispersal of the vaporized insect repellent around the device 10. In embodiments, as the vaporized repellent spreads out of the openings 14a and around the device 10, it provides an area of vaporized repellent around the device. This area will generally be substantially insect free. As noted above, the switch 12a may be used in conjunction with one or more timers or other control elements which may be provided in or connected to the heating circuit 12h, or the control circuit 17, to control activation of the heating element 12f to control vaporization of the insect repellent material M to maintain or expand the insect free area of vaporized repellent. In embodiments, the switch 12a may be used to deactivate the heating element 14f or to reset the one or more timers. In embodiments, the heating element 14f will deactivate automatically once the timer counts down to 0 (or up to the predetermined time limit). In embodiments, the heating element 12f may be turned on and off in a desired pattern upon actuation of the switch 12a, for example based on the operation of heating circuit 12h or control circuit 17 or other programmable device or controller, for example, which may be provided on printed circuit board 12g, or elsewhere. In embodiments, the power source 30 may also power the heating circuit 12h and/or programmable device or controller such as the control circuit 17. In embodiments, the switch 12a may be embodied as any suitable input device such as a button, slider, or selector to name a few.

When all, or substantially all of the insect repellent material M in the cartridge 14 is vaporized, the cartridge may be removed and replaced. In embodiments, the cartridge 14 may be removed, refilled with insect repellent material M and then placed back on the base 12. In embodiments, the cartridge 14 may be removed and replaced with a second cartridge having the same construction as the cartridge 14.

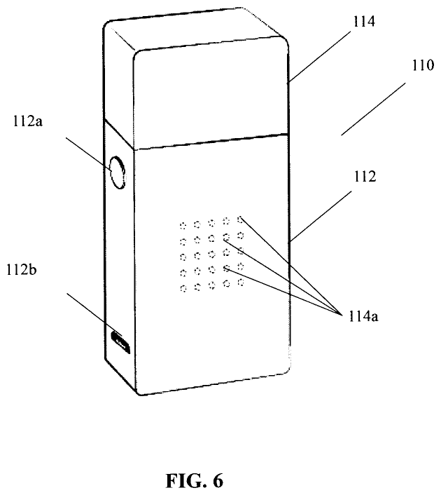

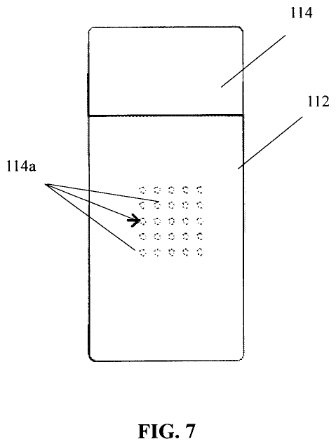

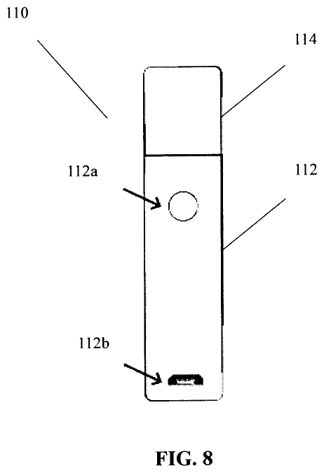

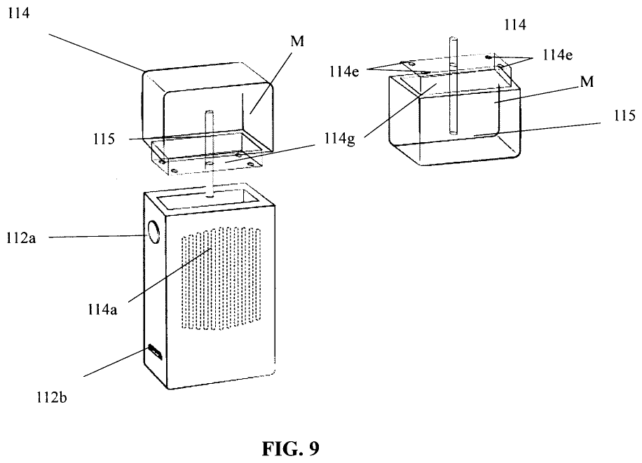

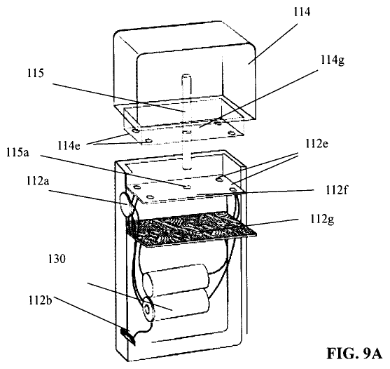

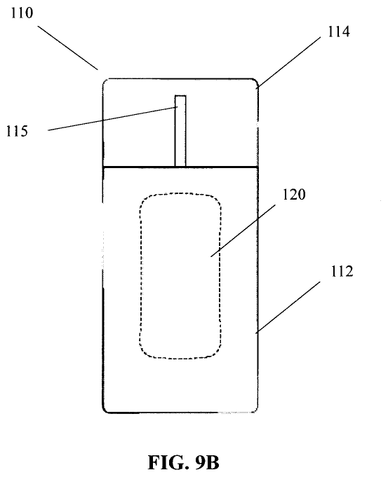

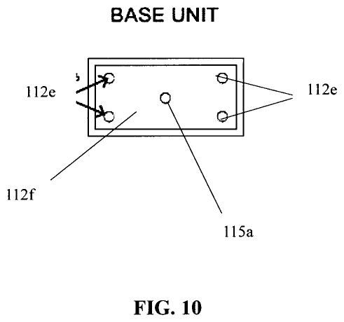

In embodiments, a vaporizer device 110 may includes an insect repellent cartridge 114 removably mounted on a base 112 as illustrated in FIGS. 6-10. In embodiments, the cartridge 114 may include a wick 115 in contact with the insect repellent material M in the cartridge 114 as indicated in FIG. 9, for example. The insect repellent material M may travel along the wick 115 into the base 112. In embodiments, the base 112 includes a receptacle or opening 115a (see FIG. 9A, for example) formed in the heating element 112f that receives the wick 115 when the cartridge 114 is mounted on the base 112. In embodiments, the base 112 may include one or more heating element(s) 112f mounted therein to heat the wick 115. As the wick 115 is heated, the insect repellent material M therein vaporizes and escapes through the openings 114a in the base 112. In embodiments, the heating element 112f in the base 112 may be operated by actuation of the switch 112a in substantially the same manner as the heating element 12f operates upon actuation of the switch 112a as discussed above and a heating circuit 12h or control circuit 17 may be used in substantially the same manner as described above. In embodiments, a charging socket 112b may be provided in the base 112 to recharge a power source 130 mounted therein that powers the heating element 112f. In embodiments, the power source 130 may be similar in structure and function to the power source 30 discussed above. In embodiments, the cartridge 114 may be removably mounted on the base 112 using fastening members 114e, 112e in substantially the same manner as the cartridge 14 is connected to the base 12 using the first and second fastening member 14e, 12e. In this embodiment, the fastening member 114e may be provided on a bottom surface of the protrusion 114e and the fastening members 112e may be formed on or attached to the heating element 112f. In this embodiment, a conductive plate between the protrusion 114g and the heating element 112f is not necessary since heat need not be transferred to the protrusion 114g. In embodiments, a heating circuit or control circuit similar to the heating circuit 12h or control circuit 17, respectively, may be provided to interact with the switch 112a in much the same manner as that described above with respect to switch 12a. In embodiments, the heating circuit may be provided on PCB 112g. The switch 112a may be connected to the power source 130 and heating element 112f (as well as the heating circuit and/or control circuit 17) in substantially the same manner as indicated in FIGS. 5A and 5B.

In operation, the user may actuate the switch 112a to activate the heating element 112f in the base 112. The heating element 112f in the base 112 may be provided adjacent to or otherwise close to the wick 115 extending through the receptacle 115a and into the base 112 from the cartridge 114. In embodiments, the wick 15 need not extend through the receptacle but may be positioned adjacent or otherwise in close proximity to it. The switch 112a may control the heating element 112f in the base 112 in much the same manner as heating element 12f is controlled by the switch 12a as described above. The heat from the heating element 112f vaporizes the insect repellent material M in the wick 115. The vaporized insect repellent exits the device 110 via the openings 114a formed in the base 112. The openings 114a are illustrated as formed in the front surface of the base 112, however may be provided elsewhere if desired. The vaporized repellent material spreads outward to provide an area of vaporized repellent around the device 110 that is substantially insect free. In embodiments, one or more fan(s) may be provided in the base 112 to spread the vaporized insect repellent material. In embodiments, the fan(s) may be controlled by actuation of the switch 112a and/or by the control circuit in the manner described above with respect to the switch 12a.

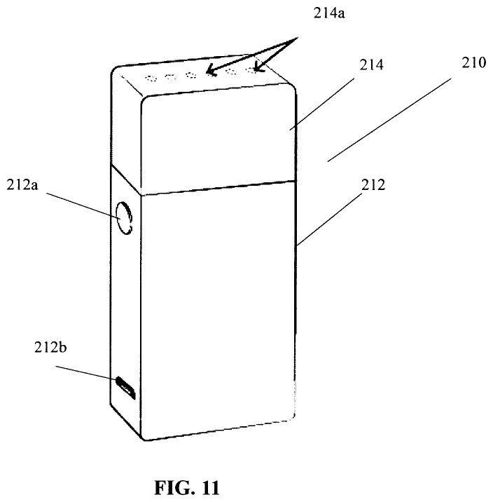

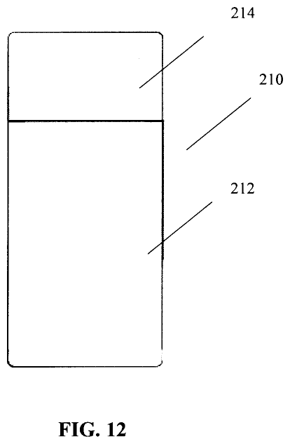

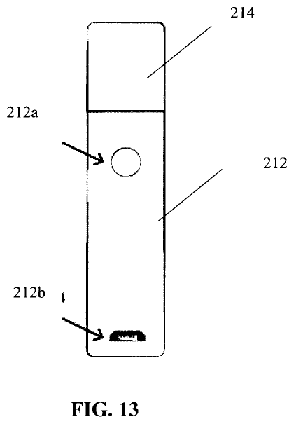

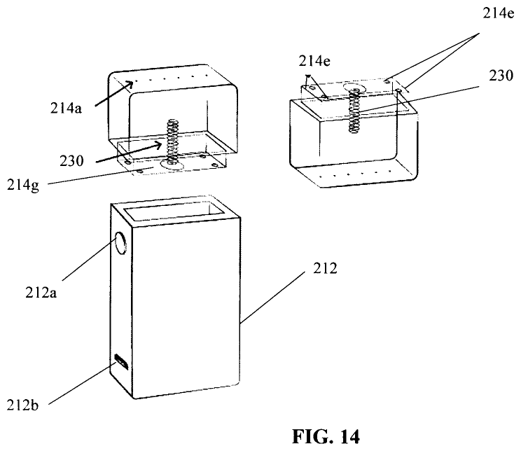

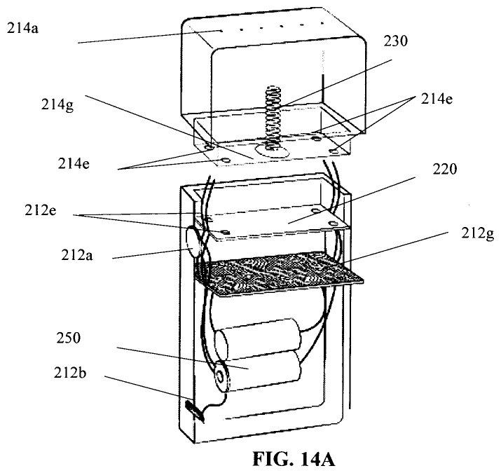

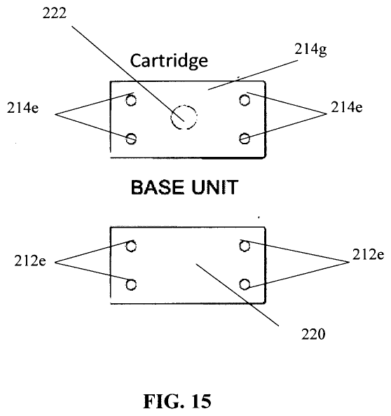

In another embodiment, such as that illustrated in FIGS. 11-15, an electric vaporizer device 210 may include an insect repellent cartridge 214 removably mounted on a base 212. In embodiments, the base 212 may include a power supply 250 (see FIG. 14A, for example), which may be structured and may function in substantially the same manner as the power supply 30. In embodiments, the insect repellent cartridge 214 may include a supply of insect repellent material M. In embodiments, the cartridge 214 may include one or more heating elements 230 mounted therein, adjacent to, near, or in the insect repellent material M. In embodiments, the base 212 may include a switch 212a that may be used to activate and/or deactivate the heating element 230. In embodiments, the top surface of the base 212 may include one or more electrical contacts 220 which are electrically connected to the power supply 250 in the base 212. In embodiments, a bottom surface of the cartridge 214, or the protrusion 214g, may include one or more complimentary contact(s) 222 (see FIG. 15, for example) to provide power to the heating element 230 from the first contact 220, for example. In embodiments, the switch 212a may activate the heating element 230, via the contacts 220, 222, in much the same manner as the switched 12a, 112a activate the heating elements 12f, 112f. In embodiments the cartridge 214 may include first fastening elements 214e that cooperate with second fastening elements 212e to removably fasten the cartridge 214 to the base 212. These fastening elements 214e, 212e may be the same or different than the fastening element 14e, 114e and 12e, 112e discussed above. In embodiments, a charging port 212b may be provided in the base 212 to allow for recharging of the power source 250 in the base 212 or to provide direct power in much the same manner described above with respect to the port 12b, 112b. The switch 212a may be connected to the power source 250 and heating element 230 (via the contacts 220, 222) in substantially the same manner as the switch 12 is connected to the power source 30 and the heating element 12f indicated in FIG. 5A. In embodiments, a heating circuit or control circuit may be used to control operation of the heating element 230 in much the same manner as the heating circuit 12h discussed above. In embodiments, the heating circuit may be provided on the PCB 212g, for example. In embodiments a control circuit similar to control circuit 17 discussed above may be included and connected to the power source 250, the switch 212a, the heating element 230 and/or the heating circuit. The control circuit may be implemented and may function in the manner described above with respect to the control circuit 17 to control activation of the heating element 230 via the contacts 220, 222.

In operation, a user may actuate the switch 212a to activate the heating element 230 which will heat the insect repellent material M in the cartridge 214. As noted above, the switch 212a may actuate the heating element 230 via the contacts 220, 222, for example, in much the same manner as switch 12a actuates the heating element 12f. In embodiments, the heating element 230 heats the insect repellent material M until it vaporizes. When the insect repellent material vaporizes, it escapes via the openings 214a in the top of the cartridge 214, which may be similar to the openings 14a discussed above with reference to FIG. 1, for example. In embodiments, one or more fans may be provided in the cartridge 214 and/or base 212 to spread the vaporized insect repellent material M around the device 210 to create or expand the substantially insect free area.

In embodiments, the power supply 250 may be provided in the cartridge 214 to power the heating element 230. In embodiments, the switch 212a may also be provided in the cartridge 214 to control activation of the heating element in substantially the same manner as the switch 12a is used to control the heating element 14f. In embodiments, where the power source and switch are provided in the cartridge, the contacts 220, 222 may not be used.

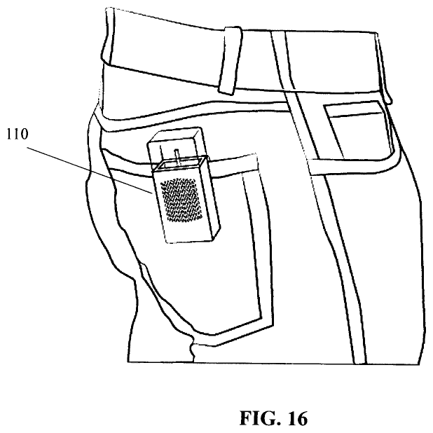

In embodiments, the insect repellent material M may include a fragrant material such that the vaporized repellent has a pleasant odor. In embodiments, the vaporizer device 10, 110, 210 may include a clip 20 (see FIG. 4B, for example) or other attachment element to allow the device to be attached to a user's clothing as can be seen in FIG. 16, for example. In embodiments, the vaporizer device 10, 110, 210 may include a stand element or leg element to allow it to be propped in a desired position on a surface. In embodiments, the vaporizer device 10, 110, 210 may include one or more solar panels that may be used to recharge the power source 30, 130, 250 include in the base 12, 112, 212.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. An electric vaporizer device comprises:
a base, wherein the base includes:
a power source;
a heating element;
an input element connected to the heating element and power source;
a cartridge removably mounted in the base, wherein the cartridge includes:
a protrusion extending from a bottom of the cartridge and sized and shaped to be received in the base; and
a reservoir area configured to hold a supply of insect repellent material,
wherein the heating element is thermally coupled to the reservoir area when the cartridge is mounted on the base such that heat from the heating element vaporizes at least a portion of the insect repellent material and the vaporized insect repellent material exits the electric vaporizer device to provide a cloud of vaporized insect repellent material around the electric vaporizer device.

2. The electric vaporizer device of claim 1, wherein the base further comprises a control circuit operatively connected to the heating element and the input element and configured to activate the heating element.

3. The electric vaporizer device of claim 2, wherein the control circuit comprises a programmable logic device configured to activate the heating element in accordance with a heating pattern.

4. The electric vaporizer device of claim 3, wherein the control circuit includes a timer wherein the control circuit is configured to activate the heating element for a predetermined period of time based on the timer.

5. The electric vaporizer device of claim 1, further comprising a heating circuit connected to the heating element and the input element and configured to activate the heating element based on input provided via the input element.

6. The electric vaporizer device of claim 5, wherein the heating circuit comprises a timer and activates the heating element for a predetermined period of time following the input from the input element.

7. The electric vaporizer device of claim 1, wherein the cartridge further comprises a top surface including one or more openings configured to allow vaporized insect repellent to exit.

8. An electric vaporizer device comprises:
a base, wherein the base includes:
a power source;
a heating element;
an input element connected to the heating element and the power source;
a cartridge removably mounted in the base, wherein the cartridge includes:
a protrusion extending from a bottom of the cartridge and sized and shaped to be received in the base;
a reservoir area configured to hold a supply of insect repellent material;
a wick extending from a first end positioned in the reservoir area and in contact with the insect repellent material to a second end that extends out of the protrusion and adjacent to the heating element when the cartridge is mounted on the base such that heat from the heating element vaporizes insect repellent material that flows from the first end of the wick to the second end of the wick and the vaporized insect repellent material exits the electric vaporizer device to provide a cloud of vaporized insect repellent material around the electric vaporizer device.

9. The electric vaporizer device of claim 8, wherein the base further comprises a control circuit operatively connected to the heating element and the input element and configured to activate the heating element.

10. The electric vaporizer device of claim 9, wherein the control circuit comprises a programmable logic device configured to activate the heating element in accordance with a heating pattern.

11. The electric vaporizer device of claim 10, wherein the control circuit includes a timer wherein the control circuit is configured to activate the heating element for a predetermined period of time based on the timer.

12. The electric vaporizer of claim 8, further comprising a heating circuit connected to the heating element and the input element and configured to activate the heating element based on input provided via the input element.

13. The electric vaporizer device of claim 12, wherein the heating circuit comprises a timer and activates the heating element for a predetermined period of time following the input from the input element.

14. The electric vaporizer device of claim 8, wherein the base further comprises a front surface including one or more openings formed therein to allow vaporized insect repellent to exit.

15. An electric vaporizer device comprises:
a base, wherein the base includes:
a power source;
a first electrical contact operatively connected to the power source;
an input element connected to the first electrical contact and operable to control power supplied to the first electrical contact;
a cartridge removably mounted in the base, wherein the cartridge includes:
a protrusion extending from a bottom of the cartridge and sized and shaped to be received in the base;
a reservoir area configured to hold a supply of insect repellent material;
a second electrical contact configured for connection to the first electrical contact; and
a heating element connected to the second electrical contact such that the heating element is activated and deactivate based on power supplied via the second electrical contact from the first electrical contact;
wherein the heating element vaporizes at least a portion of the insect repellent material and the vaporized insect repellent material exits the electric vaporizer device to provide a cloud of vaporized insect repellent material around the electric vaporizer device.

16. The electric vaporizer device of claim 15, wherein the base further comprises a control circuit operatively connected to the input element and the first electrical contact and configured to control power provided to the first electrical contact.

17. The electric vaporizer device of claim 16, wherein the control circuit comprises a programmable logic device configured to control the supply of power in accordance with a heating pattern.

18. The electric vaporizer device of claim 17, wherein the control circuit includes a timer wherein the control circuit is configured to provide power to the first electrical contract for a predetermined period of time based on the timer.

19. The electric vaporizer of claim 15, further comprising a heating circuit connected to the heating element and the input element and configured to activate the heating element based on input provided via the input element.

20. The electric vaporizer device of claim 19, wherein the heating circuit comprises a timer and activates the heating element for a predetermined period of time following the input from the input element.

21. The vaporizer device of claim 15, wherein the cartridge further comprises a top surface including one or more openings configured to allow vaporized insect repellent to exit.
